(19) United States
(12) Patent Application Publication
(10) Pub. No.: US 2021/0359916 A1
(43) Pub. Date: Nov. 18, 2021

(54) COMMUNICATION APPARATUS, CONTROL METHOD FOR CONTROLLING COMMUNICATION APPARATUS, AND STORAGE MEDIUM

(71) Applicant: CANON KABUSHIKI KAISHA, Tokyo (JP)

(72) Inventor: Tetsuya Yamamoto, Kanagawa (JP)

(21) Appl. No.: 17/307,557

(22) Filed: May 4, 2021

(30) Foreign Application Priority Data
May 14, 2020 (JP) 2020-085003

(51) Int. Cl. H04L 12/24

(52) U.S. Cl. CPC H04L 41/14; H04W 84/042

(57) ABSTRACT

A communication apparatus includes an acquisition unit configured to acquire slice information regarding a network slice specified by a network, and a control unit configured to control display according to a result of the acquisition of the slice information.

### BACKGROUND

### Field of the Disclosure

The present disclosure relates to a communication apparatus, a control method for controlling a communication apparatus, and a storage medium.

### Description of the Related Art

3rd Generation Partnership Project (3GPP) specifications define network slicing that virtually divides a network. The network slicing is a mechanism for specifying network characteristics such as a bandwidth and a delay and then providing a communication service. Examples of the network slicing include a method in which a communication terminal specifies a network slice, and a method in which a network specifies a network slice. In the method in which the communication terminal specifies a network slice, the communication terminal requests the use of a particular network slice and is permitted to use the particular network slice by the network. In the method in which the network specifies a network slice, the communication terminal uses a network slice permitted or specified by the network. If a network slice is not permitted or specified by the network, the communication terminal connects to a public network without using a network slice.

Japanese Unexamined Patent Application Publication No. 2019-511179 discusses a technique for, in order for a user of a communication terminal to select a desired network slice, indicating available network slices to the user through a user interface of the communication terminal and displaying the selection result of the user.

In the technique discussed in Japanese Unexamined Patent Application Publication No. 2019-511179, however, the user selects an available network slice. Thus, Japanese Unexamined Patent Application Publication No. 2019-511179 does not discuss how a network slice specified by a network is displayed on the communication terminal in the method in which a network specifies a network slice. As a result of this, it is difficult for the user of the communication terminal to identify a network slice specified by the network.

There is a need in the art to enable a user of a terminal to identify a network slice specified by a network.

### SUMMARY

According to an aspect of the present disclosure, a communication apparatus includes an acquisition unit configured to acquire slice information regarding a network slice specified by a network, and a control unit configured to control display according to a result of the acquisition of the slice information.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of a communication system according to a first exemplary embodiment.

FIG. 2 is a block diagram illustrating an example of a hardware configuration of each communication terminal in FIG. 1.

FIG. 3 is a block diagram illustrating an example of a functional configuration of each communication terminal in FIG. 1.

FIG. 4 is a diagram illustrating an example of slice information in FIG. 1,

FIG. 5 is a diagram illustrating examples of a display content to be displayed on the communication terminal in FIG. 2.

FIG. 6 is a diagram illustrating an example of semantic information indicated by the communication terminal in FIG. 2.

FIG. 7 is a flowchart illustrating an operation of the communication terminal according to the first exemplary embodiment,

FIG. 8 is a block diagram illustrating an example of a configuration of a communication system according to a second exemplary embodiment.

FIG. 9 is a flowchart illustrating an operation of a communication terminal according to the second exemplary embodiment.

FIG. 10 is a diagram illustrating an example of slice information acquired by a communication terminal according to a third exemplary embodiment.

FIG. 11 is a diagram illustrating an example of semantic information indicated by the communication terminal according to the third exemplary embodiment.

FIG. 12 is a flowchart illustrating an operation of the communication terminal according to the third exemplary embodiment.

FIG. 13 is a flowchart illustrating an operation of a communication terminal according to a fourth exemplary embodiment.

FIG. 14 is a flowchart illustrating an operation of a communication terminal according to a fifth exemplary embodiment.

FIG. 15 is a block diagram illustrating an example of a functional configuration of a core network apparatus according to a sixth exemplary embodiment,

FIG. 16 is a flowchart illustrating an operation of the core network apparatus according to the sixth exemplary embodiment.

### DESCRIPTION OF THE EMBODIMENTS

With reference to the attached drawings, exemplary embodiments of the present disclosure will be described in detail below. The following exemplary embodiments do not limit the present disclosure, and not all the combinations of the features described in the exemplary embodiments are essential for a method for solving the issues in the present disclosure. The configurations of the exemplary embodiments can be appropriately modified or changed depending on the specifications of an apparatus to which the present invention is applied, or various conditions (the use conditions and the use environment). The technical scope of the present disclosure is determined by the appended claims, and is not limited by the following individual exemplary embodiments,

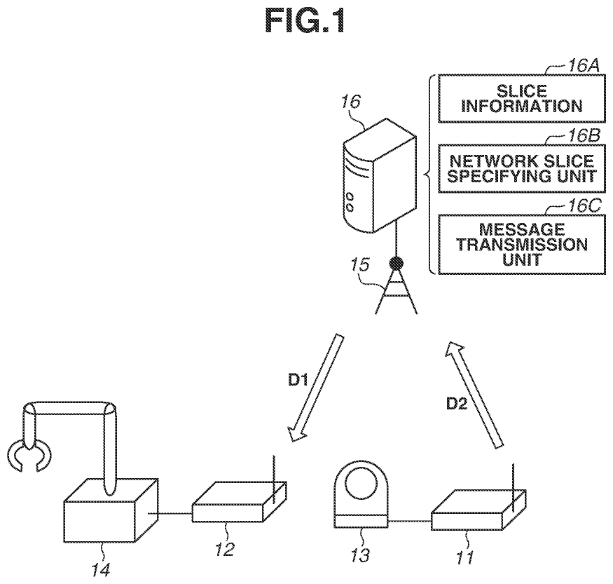

FIG. 1 is a block diagram illustrating an example of the configuration of a communication system according to a first exemplary embodiment.

In FIG. 1, the communication system includes communication terminals 11 and 12 and a core network apparatus 16. The communication terminal 11 is connected to a network camera 13. The communication terminal 12 is connected to a robot arm 14. Using a network slice specified by the core network apparatus 16, the communication terminal 11 and 12 each can receive a communication service provided by the core network apparatus 16. At this time, neither the communication terminal 11 nor 12 itself requests the use of a particular network slice.

The core network apparatus 16 manages a network connection between the communication terminal 11 or 12 and a base station 15. At this time, the core network apparatus 16 specifies a network slice to be provided to the communication terminal 11 or 12 and permits the communication terminal 11 or 12 to use the network slice. The core network apparatus 16 includes slice information 16A, a network slice specifying unit 16B, and a message transmission unit 16C, The slice information 16A is information regarding the network slice specified by the core network apparatus 16, The slice information 16A can include a slice service type value corresponding to a slice service type that can be provided by the core network apparatus 16. The network slice specifying unit 16B can specify the network slice indicated by the slice information 16A for the communication terminal 11 or 12. For example, the network slice specifying unit 16B can specify network characteristics such as a bandwidth and a delay as the network slice to be provided to the communication terminal 11 or 12. The message transmission unit 16C transmits a message including the slice information 16A that enables the communication terminal 11 or 12 to specify a display content according to the network slice. At this time, the slice information 16A can include a value (e.g., the slice service type value) associated with the display content to be displayed on the communication terminal 11 or 12. Then, the communication terminal 11 or 12 sets the display content based on the slice service type value, which allows a user of the communication terminal 11 or 12 to identify the network slice specified by the network.

When the network camera 13 uploads captured data D2 to a data server, the data D2 is transmitted from the network camera 13 to the communication terminal 11, the base station 15 and the data server in this order, Δt this time, to upload the captured data D2 of the network camera 13 to the data server in real time, the communication terminal 11 can use a low latency network slice.

The low latency network slice is specified by the core network apparatus 16. At this time, if the communication terminal 11 receives a message including the slice information 16A regarding a network slice from the core network apparatus 16, the communication terminal 11 acquires the slice information 16A. Then, the communication terminal 11 performs display according to the result of the acquisition of the slice information 16A. This enables the user of the communication terminal 11 to confirm whether the network slice specified by the core network apparatus 16 is a low latency network slice.

When the robot arm 14 operates based on control data D1 from a remote control server, the data D1 is transmitted from the remote control server to the base station 15, the communication terminal 12 and the robot arm 14 in this order. At this time, to prevent the robot arm 14 from malfunctioning, the communication terminal 12 can use a highly reliable network slice.

The highly reliable network slice is specified by the core network apparatus 16. At this time, if the communication terminal 12 receives a message including the slice information 16A regarding a network slice from the core network apparatus 16, the communication terminal 12 acquires the slice information 16A. Then, the communication terminal 12 performs display according to the result of the acquisition of the slice information 16A. This enables the user of the communication terminal 12 to confirm whether the network slice specified by the core network apparatus 16 is a highly reliable network slice.

The configuration and the operation of the communication terminal 11 or 12 in FIG. 1 will be specifically described below.

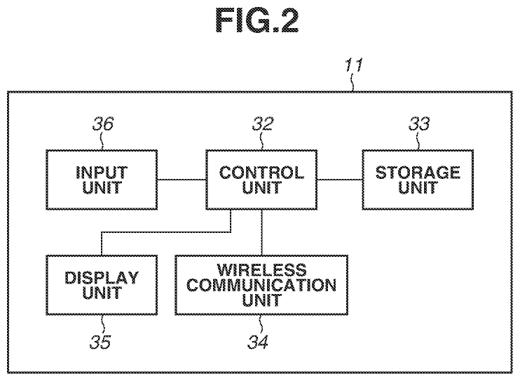

FIG. 2 is a block diagram illustrating an example of the hardware configuration of each communication terminal in FIG. 1. Although the communication terminal 11 is taken as an example in FIG. 2, the communication terminal 12 can also be similarly configured. In FIG. 2, the communication terminal 11 includes a control unit 32, a storage unit 33, a wireless communication unit 34, a display unit 35, and an input unit 36.

The control unit 32 executes a control program stored in the storage unit 33, thereby controlling the entirety of the communication terminal 11, The control unit 32 may include one or more processors. Each processor may be a central processing unit (CPU), or may be a graphics processing unit (GPU). The control unit 32 may include a hardware circuit such as an accelerator that performs a part of processing. This hardware circuit may be a field-programmable gate array (FPGA) or an application-specific integrated circuit (ASIC).

The storage unit 33 stores various pieces of information such as the control program to be executed by the control unit 32, a communication parameter, and the captured data D2. The storage unit 33 can be composed of one or more semiconductor memories such as a read-only memory (ROM) or a random-access memory (RAM). The storage unit 33 may include an auxiliary storage device such as a hard disk device or a solid-state drive (SSD), Various operations executed by the communication terminal 11 are achieved by the control unit 32 executing the control program stored in the storage unit 33.

The wireless communication unit 34 performs Long-Term Evolution (LTE) or fifth generation (5G) cellular communication (mobile communication) compliant with the 3rd Generation Partnership Project (3GPP) standard. At this time, the wireless communication unit 34 can access the core network apparatus 16 via the base station 15 in FIG. 1.

The display unit 35 performs various types of display regarding the specifying of a network slice. The display unit 35 outputs visually recognizable information. The display unit 35 is, for example, a liquid crystal display (LCD) or a light-emitting diode (LED) display. The display unit 35 may have a function of outputting a sound, such as a loudspeaker. The user provides various inputs using the input unit 36, and the input unit 36 acquires sensor information.

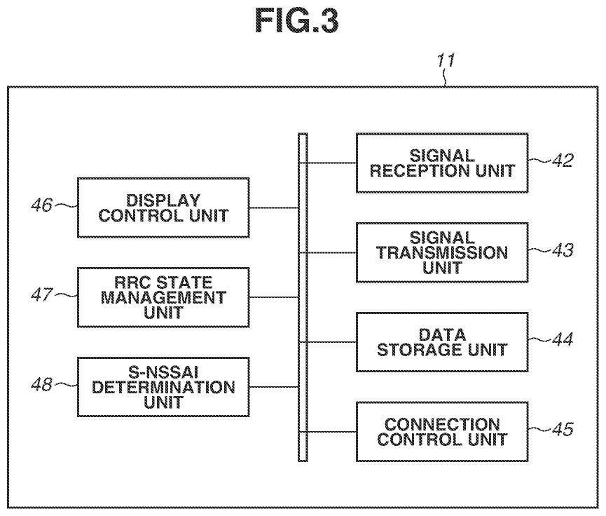

FIG. 3 is a block diagram illustrating an example of the functional configuration of each communication terminal in FIG. 1. Although the communication terminal 11 is taken as an example in FIG. 3, the communication terminal 12 can also be similarly configured. In a case where functions are achieved by software among the functions of function modules of the communication terminal 11 illustrated in FIG. 3, a program for providing the functions of the function modules is stored in a memory such as a ROM. Then, the program is loaded into a RAM and executed by a CPU. In a case where functions are achieved by hardware, for example, a dedicated circuit may be automatically generated on an FPGA using a predetermined compiler according to the program for achieving the functions of the function modules. Alternatively, a gate array circuit may be formed similarly to the FPGA, and the functions may be achieved as hardware. Yet alternatively, the functions may be achieved by an ASIC. The configurations of functional blocks illustrated in FIG. 3 are merely examples. Alternatively, a plurality of functional blocks may be included in a single functional block, or any of the functional blocks may be divided into blocks for performing a plurality of Functions.

In FIG. 3, the communication terminal 11 includes a signal reception unit 42, a signal transmission unit 43, a data storage unit 44, a connection control unit 45, a display control unit 46, and a Radio Resource Control (RRC) state management unit 47. The communication terminal 11 also includes a Single-Network Slice Selection Assistance Information (S-NSSAI) determination unit 48.

The signal reception unit 42 and the signal transmission unit 43 perform LTE or 5G cellular network communication compliant with the 3GPP standard with an opposing apparatus as a communication partner.

The data storage unit 44 stores a program and authentication information.

The connection control unit 45 performs processing regarding connection with and disconnection from a cellular network base station.

The display control unit 46 performs the process of controlling a screen displayed on the display unit 35 in FIG. 2. At this time, the display control unit 46 can control display according to the result of the acquisition of the slice information 16A regarding a network slice specified by the core network apparatus 16 in FIG. 1.

The RRC state management unit 47 grasps and manages an RRC state. For example, the RRC state management unit 47 grasps and manages whether an RRC connection is completed based on the fact that the communication terminal 11 transitions from RRC_Idle to RRC_Connected.

The S-NSSAI determination unit 48 determines whether data is received, and also determines the type of the S-NSSAI data. The S-NSSAI data includes the slice service type value assigned to the slice service type, Δt this time, the S-NSSAI determination unit 48 can acquire the slice information 16A based on the result of receipt of a message including the slice information 16A regarding a network slice specified by the core network apparatus 16.

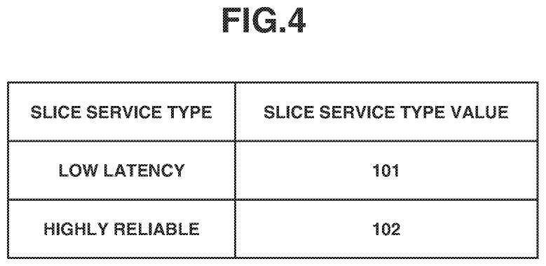

FIG. 4 is a diagram illustrating an example of the slice information in FIG. 1.

In FIG. 4, in the slice information 16A in FIG. 1, the slice service type value is defined by a core network so that the core network apparatus 16 specifies a network slice. For example, if the slice service type is “loin latency”, “101” is assigned as the slice service type value. If the slice service type is “highly reliable”, “102” is assigned as the slice service type value.

Based on the result of the acquisition of the slice service type value defined by the core network, the communication terminal 11 or 12 can display, on the display unit 35, information regarding a network slice specified by the core network.

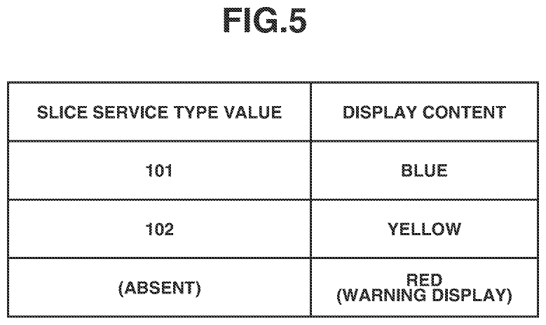

FIG. 5 is a diagram illustrating examples of the display content to be displayed on the communication terminal in FIG. 2.

In FIG. 5, the storage unit 33 in FIG. 2 stores a correspondence table between the slice service type value defined by the core network and the display content to be displayed on the display unit 35. For example, if the slice service type value is “101”, “blue” is assigned as the display content. If the slice service type value is “102”, “yellow” is assigned as the display content if the slice service type value is absent, “red” indicating warning display may be assigned.

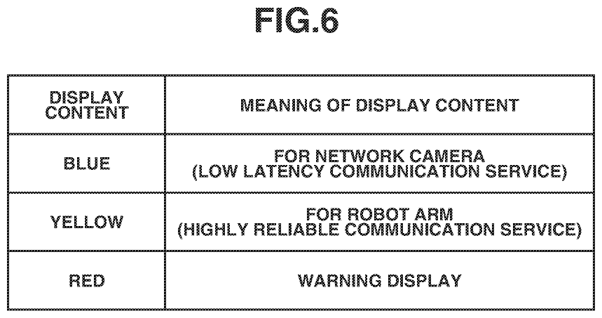

FIG. 6 is a diagram illustrating an example of semantic information indicated by the communication terminal in FIG. 2.

In FIG. 6, the communication terminal 11 can indicate to the user the display content assigned in the correspondence table in FIG. 5 and the meaning of the display content. For example, if the display content is “blue”, the communication terminal 11 can indicate the meaning “for a network camera (a low latency communication service)”. If the display content is “yellow”, the communication terminal 11 can indicate the meaning “for a robot arm (a highly reliable communication service)”. If the display content is “red”, the communication terminal 11 can indicate the meaning “a warning”.

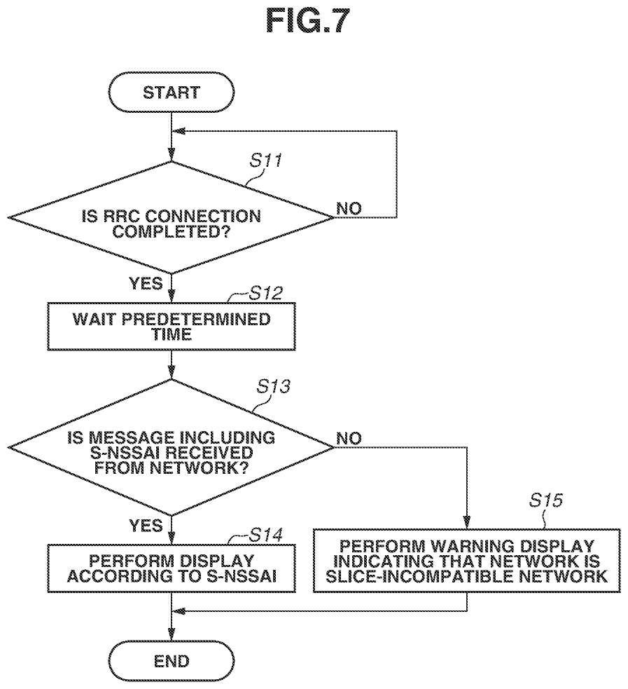

FIG. 7 is a flowchart illustrating the operation of the communication terminal according to the first exemplary embodiment. FIG. 7 illustrates processing in which the communication terminal 11 or 12 displays a network slice specified by the core network.

Steps in FIG. 7 are achieved by the control unit 32 reading and executing a program stored in the storage unit 33 of the communication terminal 11 or 12. Alternatively, at least a part of the flowchart illustrated in FIG. 7 may be achieved by hardware. In a case where at least a part of the flowchart is achieved by hardware, for example, a dedicated circuit may be automatically generated on an FPGA using a predetermined compiler according to the program for achieving the steps. Yet alternatively, a gate array circuit may be formed similarly to the FPGA, and at least a part of the flowchart may be achieved as hardware. Yet alternatively, at least a part of the flowchart may be achieved by an ASIC.

In this case, blocks in the flowchart illustrated in FIG. 7 can be regarded as hardware blocks. Alternatively, a plurality of blocks may be collectively configured as a single hardware block, or a single block may be configured as a plurality of hardware blocks.

In FIG. 7, in step S11, the control unit 32 determines whether an RRC connection is completed. If the RRC connection is not completed (No in step S11), the processing returns to step S11.

If, on the other hand, the RRC connection is completed (Yes in step S11), then in step S12, the control unit 32 waits a predetermined time. The predetermined time is defined by the communication terminal 11 or 12 as a sufficient time to receive a message including S-NSSAI from the network. The predetermined time is one second, for example, but may be another time.

Next, in step S13, the control unit 32 determines whether the control unit 32 receives a message including S-NSSAI from the network. If the control unit 32 receives a message including S-NSSAI from the network (Yes in step S13), then in step S14, the control unit 32 controls the display unit 35 to perform display according to the S-NSSAI.

If, on the other hand, the control unit 32 does not receive a message including S-NSSAI from the network (No in step S13), then step S15, the control unit 32 controls the display unit 35 to perform warning display for indicating that the network is a slice-incompatible network.

In a case where the control unit 32 controls the display unit 35 to perform the display according to the S-NSSAI, the control unit 32 references the display content in FIG. 5 based on the slice service type value included in the S-NSSAI data. Consequently, the control unit 32 can control the display unit 35 to display blue if the slice service type is “low latency”, or display yellow if the slice service type is “highly reliable”, or display red if the network is a slice-incompatible network.

As described above, according to the first exemplary embodiment, a communication terminal acquires slice information regarding a network slice specified by a network based on the result of receipt of a message including the slice information. A display control unit controls display according to the result of the acquisition of the slice information. This enables a user of the communication terminal to determine whether the network slice specified by the network is as expected,

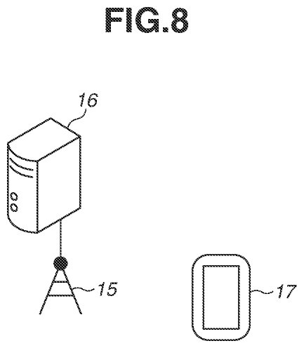

FIG. 8 is a block diagram illustrating an example of the configuration of a communication system according to a second exemplary embodiment.

In FIG. 8, the communication system according to the second exemplary embodiment includes a communication terminal 17 instead of the communication terminals 11 and 12 in FIG. 1. The hardware configuration of the communication terminal 17 and the functional configuration of software in the communication terminal 17 are similar to the configurations in FIGS. 2 and 3, The communication terminal 17 can use a network slice specified by the core network and can also itself request the use of a particular network slice,

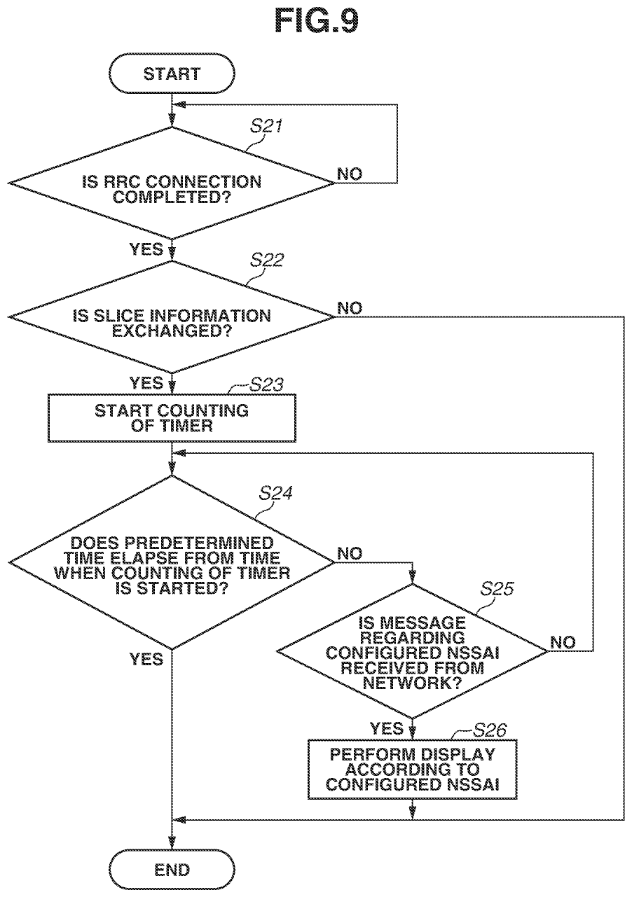

FIG. 9 is a flowchart illustrating the operation of the communication terminal according to the second exemplary embodiment. FIG. 9 illustrates processing in which the communication terminal 17 in FIG. 8 displays a network slice specified by the core network.

In FIG. 9, in step S21, the control unit 32 determines whether an RRC connection is completed. If the RRC connection is not completed (No in step S21), the processing returns to step S21.

If, on the other hand, the RRC connection is completed (Yes in step S21), then in step S22, the control unit 32 determines whether the communication terminal 17 exchanges the slice information 16A with the core network. If the communication terminal 17 does not exchange the slice information 16A with the core network (No in step S22), this means that the network to which the communication terminal 17 is currently attempting to connect is not compatible with a network slice. Thus, the processing ends.

If, on the other hand, the communication terminal 17 exchanges the slice information 16A with the core network (Yes in step S22), then in step S23, the control unit 32 starts the counting of a timer.

Next, in step S24, the control unit 32 determines whether a predetermined time elapses from the time when the counting of the timer is started. The predetermined time is 500 milliseconds, for example, but may be another time. If the predetermined time elapses from the time when the counting of the timer is started (Yes in step S24), the control unit 32 determines that a timeout has occurred. Then, the processing ends.

If, on the other hand, the predetermined time does not elapse from the time when the counting of the timer is started (No in step S24), then in step S25, the control unit 32 determines whether the control unit 32 receives a message regarding Configured NSSAI from the network. If the control unit 32 does not receive a message regarding Configured NSSAI from the network (No in step S25), the processing returns to step S24.

If, on the other hand, the control unit 32 receives a message regarding Configured NSSAI from the network (Yes in step S25), then in step S26, the control unit 32 controls the display unit 35 to perform display according to the Configured NSSAI.

In a case where the control unit 32 controls the display unit 35 to perform the display according to the Configured NSSAI, the control unit 32 controls the display unit 35 to display the slice service type value itself included in the Configured NSSAI data. Consequently, if the network to which the communication terminal 17 is to connect is not compatible with a slice service, the control unit 32 can control the display unit 35 to display nothing. If the network is compatible with a slice service, the control unit 32 can control the display unit 35 to display the slice service type value.

As described above, according to the second exemplary embodiment, based on the result of exchange of slice information with a network, a control unit controls display according to the result of acquisition of the slice information regarding a network slice specified by the network. This enables a user of a communication terminal to identify the presence or absence of a slice service and a slice service type.

In a third exemplary embodiment, the communication terminal 11 or 12 in FIG. 1 displays information regarding a network slice specified by a private (or occasionally, on-premises) core network. The hardware configuration of the communication terminal 11 or 12 and the functional configuration of software in the communication terminal 11 or 12 according to the present exemplary embodiment are similar to the configurations in FIGS. 2 and 3.

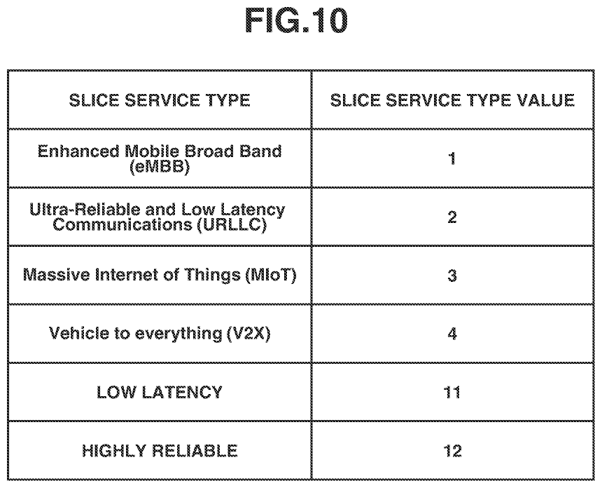

FIG. 10 is a diagram illustrating an example of the slice information acquired by the communication terminal according to the third exemplary embodiment.

In FIG. 10, the slice service type value is defined by the private core network so that the private core network specifies a network slice. For example, if the slice service type value is “1”, “2”, “3”, or “4”, the slice service type is defined by 3GPP. If the slice service type value is “11” or “12”, the slice service type is uniquely defined by the private core network.

Based on the result of the acquisition of the slice service type value defined by the private core network, the communication terminal 11 or 12 can display, on the display unit 35, information regarding a network slice specified by the private core network. In this case, based on a classification to which slice information acquired from the network belongs, the control unit 32 can control display according to the classification to which the slice information belongs. This classification is set, for example, based on the slice service type value defined by the private core network,

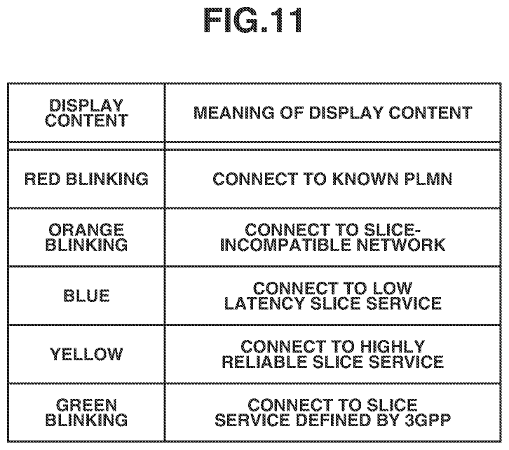

FIG. 11 is a diagram illustrating an example of semantic information indicated by the communication terminal according to the third exemplary embodiment.

In FIG. 11, the communication terminal 11 or 12 can indicate to the user the display content to be displayed on the display unit 35 and the meaning of the display content. For example, if the display content is “red blinking”, the communication terminal 11 or 12 can indicate the meaning “connect to a known public land mobile network (PLMN)”, “Known” as used herein refers to a case where the PLMN is included in a code (MCC (Mobile Country Code) and MNC (Mobile Network Code) which are assigned to an operator) described in Recommendation International Telecommunication Union-Telecommunication Standardization Sector (ITU-T) E.212. If the display content is “orange blinking”, the communication terminal 11 or 12 can indicate the meaning “connect to a slice-incompatible network”. If the display content is “blue”, the communication terminal 11 or 12 can indicate the meaning “connect to a low latency slice service”. If the display content is “yellow”, the communication terminal 11 or 12 can indicate the meaning “connect to a highly reliable slice service”. If the display content is “green blinking”, the communication terminal 11 or 12 can indicate the meaning “connect to a slice service defined by 3GPP”.

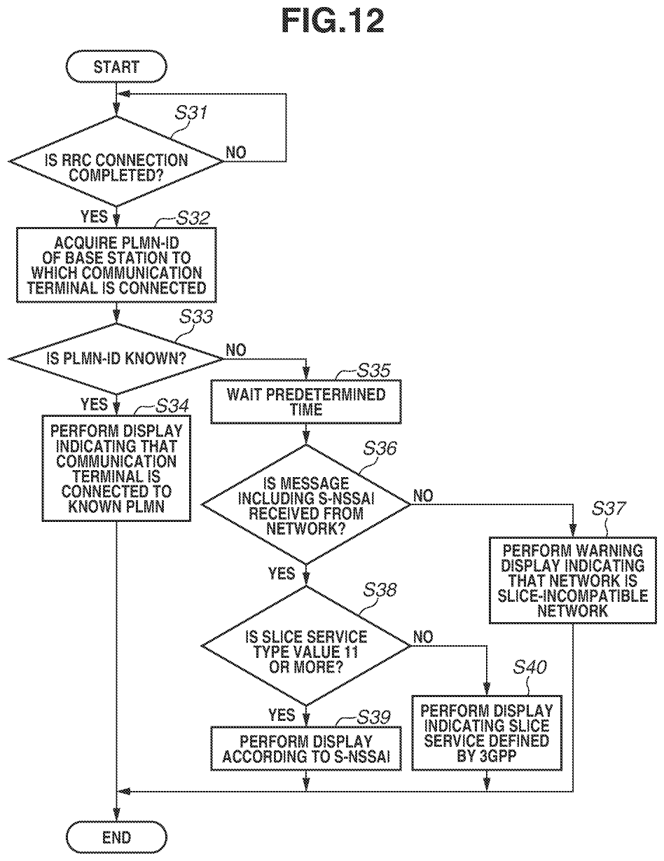

FIG. 12 is a flowchart illustrating the operation of the communication terminal according to the third exemplary embodiment. 12 illustrates processing in which the communication terminal 11 or 12 displays a network slice specified by the private core network.

In FIG. 12, in step S31, the control unit 32 determines whether an RRC connection is completed. If the RRC connection is not completed (No in step S31), the processing returns to step S31.

If, on the other hand, the RRC connection is completed (Yes in step S31), then in step S32, the control unit 32 acquires a public land mobile network identifier (PLAIN-ID) notified by a base station with which the communication terminal 11 or 12 is in the RRC connection.

Next, in step S33, the control unit 32 determines whether the PLMN-ID is known. If the PLMN-ID is known (Yes in step S33), then in step S34, the control unit 32 controls the display unit 35 to perform display indicating that the communication terminal 11 or 12 is connected to a known PLMN, This enables the user to determine that the network to which the communication terminal 11 or 12 is connected is not the private core network.

If, on the other hand, the PLMN-ID is not known (No in step S33), then in step S35, the control unit 32 waits a predetermined time. The predetermined time is defined by the communication terminal 11 or 12 as a sufficient time to receive a message including S-NSSAI from the network. The predetermined time is one second, for example, but may be another time.

Next, in step S36, the control unit 32 determines whether the control unit 32 receives a message including S-NSSAI from the network. If the control unit 32 does not receive a message including S-NSSAI from the network (No in step S36), then in step S37, the control unit 32 controls the display unit 35 to perform warning display for indicating that the network is a slice-incompatible network.

If, on the other hand, the control unit 32 receives a message including S-NSSAI from the network (Yes in step S36), then in step S38, the control unit 32 determines whether the slice service type value included in the S-NSSAI data is 11 or more. As illustrated in FIG. 10, if the slice service type value is 11 or more, this means that a unique slice service in the private core network is being used. If not, this means that a slice service defined by 3GPP is being used.

Thus, if the slice service type value is 11 or more (Yes in step S38), then in step S39, the control unit 32 controls the display unit 35 to perform display according to the S-NSSAI.

If, on the other hand, the slice service type value is not 11 or more (No in step S38), then in step S40, the control unit 32 controls the display unit 35 to perform display indicating that a slice service defined by 3GPP is being used.

As described above, according to the third exemplary embodiment, a control unit can change a display content according to a network as a connection destination. For example, the control unit changes the display content according to a connection to a known HAIN, a connection to a slice-incompatible network, a connection to a unique slice service in an private core network, or a connection to a slice service defined by 3GPP. This enables a user of a communication terminal to determine whether a network slice specified by the network is as expected.

In a fourth exemplary embodiment, the communication terminal 12 in FIG. 1 switches the display of information regarding a network slice specified by the private core network according to the content of a communication function set by the communication terminal 12. The hardware configuration of the communication terminal 12 and the functional configuration of software in the communication terminal 12 according to the present exemplary embodiment are similar to the configurations in FIGS. 2 and 3. In the present exemplary embodiment, the robot arm 14 functions as an input apparatus regarding the setting of a slice service in the communication terminal 12. For example, the robot arm 14 requests the use of a highly reliable network slice. At this time, the robot arm 14 sets “11”, which is the slice service type value assigned to a highly reliable network defined by the private core network, for the communication terminal 12. The communication terminal 12 receives the slice service type value “11” from the input unit 36, and the control unit 32 stores the slice service type value “11” in the storage unit 33.

Then, the control unit 32 compares the slice service type value “11” held in the storage unit 33 and the slice service type value corresponding to the slice service type specified by the private core network. Then, the control unit 32 controls display according to the result of the comparison of the slice service type values. This enables the user of the communication terminal 12 to identify whether the robot arm 14 is connected to a highly reliable network slice requested by the robot arras 14.

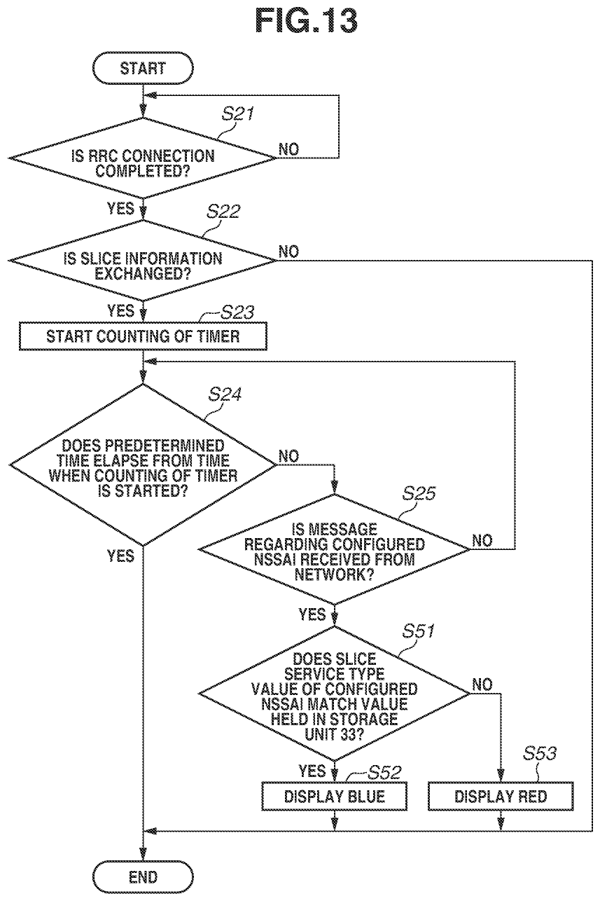

FIG. 13 is a flowchart illustrating the operation of the communication terminal according to the fourth exemplary embodiment. FIG. 13 illustrates processing in which the communication terminal 12 performs display based on the result of the comparison of the slice service type value specified by the core network and the slice service type value set for the communication terminal 12.

In FIG. 13, the control unit 32 executes the processes of steps S21 to S25 in FIG. 9. Then, the communication terminal 12 receives a message regarding Configured NSSAI from the network (Yes in step S25). At this time, in step S51, the control unit 32 determines whether the slice service type value of the received. Configured NSSAI matches the value held in the storage unit 33.

If the slice service type value of the received Configured NSSAI matches the value held in the storage unit 33 (Yes in step S25), then in step S52, the control unit 32 controls the display unit 35 to display blue.

If, on the other hand, the slice service type value of the received Configured. NSSAI does not match the value held in the storage unit 33 (No in step S25), then in step S53, the control 32 controls the display unit 35 to display red.

As described above, according to the fourth exemplary embodiment, a communication terminal holds a communication function of the communication terminal and compares the content of the held communication function and slice information regarding a network slice specified by a network. Then, the communication terminal performs display according to the result of the comparison of the content of the communication function held in the communication terminal and the slice information regarding the network slice specified by the network. This enables a user of the communication terminal to identify whether the communication terminal is connected to a network slice requested by the communication terminal.

In a fifth exemplary embodiment, in a case where the communication terminal 11 or 12 in FIG. 1 itself does not set a network slice, the communication terminal 11 or 12 displays a network slice specified by the core network. The hardware configuration of the communication terminal 11 or 12 and the functional configuration of software in the communication terminal 11 or 12 according to the present exemplary embodiment are similar to the configurations in FIGS. 2 and 3. The communication terminal 11 or 12 can use a network slice specified by the core network and can also itself request the use of a particular network slice.

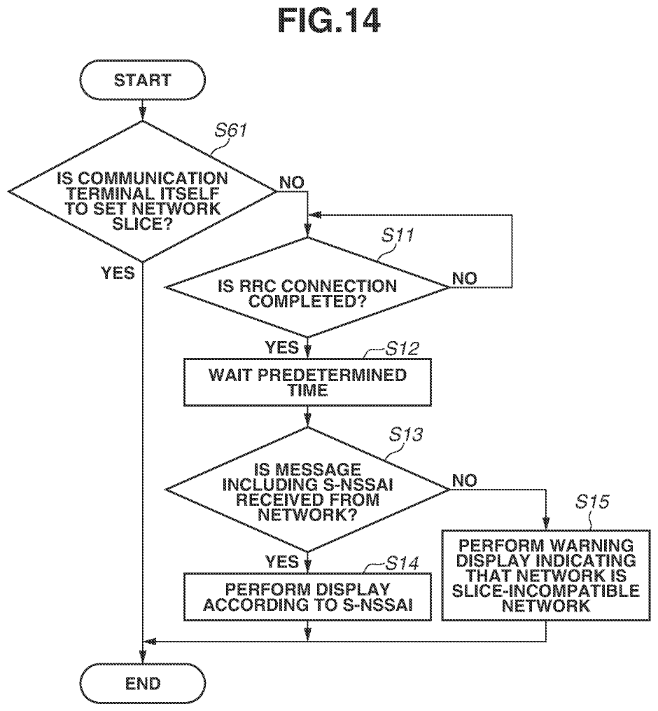

FIG. 14 is a flowchart illustrating the operation of the communication terminal according to the fifth exemplary embodiment.

In FIG. 14, in step S61, the control unit 32 determines whether the communication terminal 11 or 12 itself is to set a network slice. If the communication terminal 11 or 12 itself is to set a network slice (Yes in step S61), the processing ends.

If, on the other hand, the communication terminal 11 or 12 itself is not to set a network slice (No in step S61), the processing proceeds to step S11 in FIG. 7, and the control unit 32 executes the processing similar to that in FIG. 7.

As described above, according to the fifth exemplary embodiment, if a communication terminal itself sets a network slice, a control unit does not control display according to the result of acquisition f slice information. Thus, only if a network slice is specified by a core network, a user of the communication terminal can determine whether the network slice is as expected.

In a sixth exemplary embodiment, if a core network apparatus cannot provide a network slice for which a communication terminal has made a setting request, the core network apparatus detaches from the communication terminal having made the setting request. At this time, the core network apparatus detaches from the communication terminal having made the setting request while maintaining an RRC connection with the communication terminal,

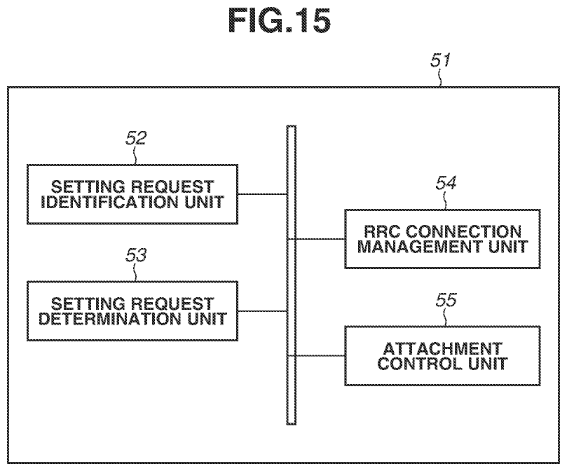

FIG. 15 is a block diagram illustrating an example of the functional configuration of a core network apparatus according to the sixth exemplary embodiment. In a case where functions are achieved by software among the functions of function modules of a core network apparatus 51 illustrated in FIG. 15, a program for providing the functions of the function modules is stored in a memory such as a ROM. Then, the program is loaded into a RAM and executed by a CPU. The configurations of functional blocks illustrated in FIG. 15 are merely examples. Alternatively, a plurality of functional blocks may be included in a single functional block, or any of the functional blocks may be divided into blocks for performing a plurality of functions.

In FIG. 15, the core network apparatus Si includes a setting request identification unit 52, a setting request determination unit 53, an RRC connection management unit 54, and an attachment control unit 55.

The setting request identification unit 52 identifies whether the communication terminal 11 or 12 makes a setting request to set a network slice. The setting request determination unit 53 determines whether the network slice for which the communication terminal 11 or 12 has made the setting request can be provided. The RRC connection management unit 54 manages an RRC connection between the communication terminal 11 or 12 having made the setting request and the base station 15. If the setting request determination unit 53 determines that the network slice for which the communication terminal 11 or 12 has made the setting request can be provided, the attachment control unit 55 attaches to the communication terminal 11 or 12 having made the setting request. If the setting request determination unit 53 determines that the network slice for which the communication terminal 11 or 12 has made the setting request cannot be provided, the attachment control unit 55 detaches from the communication terminal 11 or 12 having made the setting request while maintaining the RRC connection with the communication terminal 11 or 12.

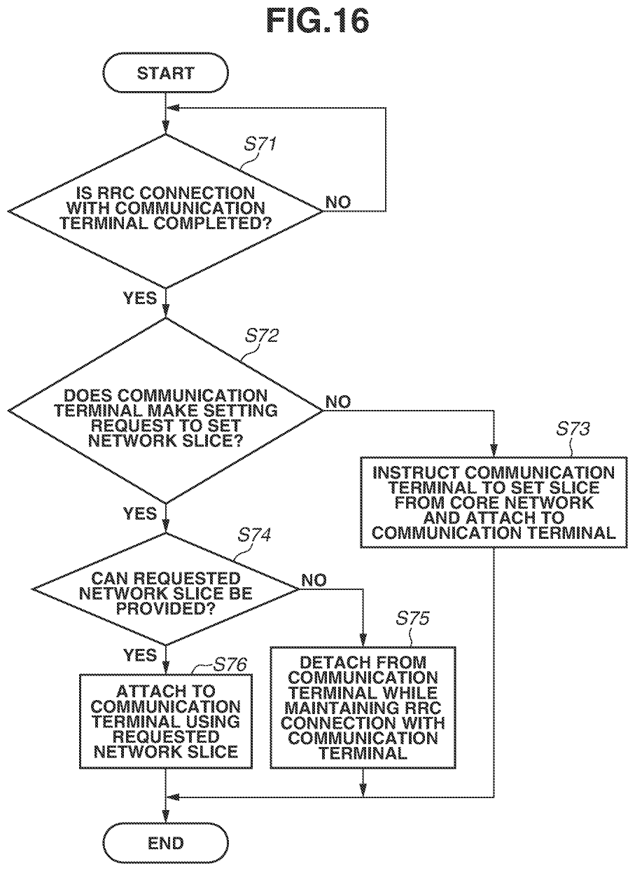

FIG. 16 is a flowchart illustrating the operation of the communication terminal according to the sixth exemplary embodiment. FIG. 16 illustrates an attachment process performed by the core network apparatus 51 in the network including the communication terminals 11 and 12 and the base station 15 in FIG. 1. Each of the communication terminals 11 and 12 operates according to the flow in FIG. 14.

In FIG. 16, in step S71, the core network apparatus 51 determines whether an RRC connection with the communication terminal 11 or 12 is completed. If the RRC connection with the communication terminal 11 or 12 is not completed (No in step S71), the processing returns to step S71.

If on the other hand, the RRC connection with the communication terminal 11 or 12 is completed (Yes in step S71), then in step S72, the core network apparatus 51 determines whether the communication terminal 11 or 12 makes a setting request to set a network slice. If the communication terminal 11 or 12 does not make a setting request to set a network slice (No in step S72), then in step S73, the core network apparatus 51 instructs the communication terminal 11 or 12 to set a slice from the core network and permits the communication terminal 11 or 12 to attach to the core network apparatus 51.

If, on the other hand, the communication terminal 11 or 12 makes a setting request to set a network slice (Yes in step S72), then in step S74, the core network apparatus 51 determines whether the network slice requested by the communication terminal 11 or 12 can be provided. If the network slice requested by the communication terminal 11 or 12 cannot be provided (No in step S74), then in step S75, the core network apparatus 51 detaches from the communication terminal 11 or 12 while maintaining the RRC connection with the communication terminal 11 or 12.

If, on the other hand, the network slice requested by the communication terminal 11 or 12 can be provided (Yes in step S74), then in step S76, the core network apparatus 51 permits the communication terminal 11 or 12 to attach to the core network apparatus 51 using the network slice requested by the communication terminal 11 or

As described above, according to the sixth exemplary embodiment, if a core network apparatus cannot provide a network slice requested by a communication terminal, the core network apparatus maintains an RRC connection with the communication terminal even in a case where the core network apparatus detaches from the communication terminal. Thus, the core network apparatus can shorten the time required for a reattachment process on the communication terminal.

### OTHER EXEMPLARY EMBODIMENTS

The present disclosure may be achieved by supplying a storage medium recording a program code of software for achieving the above functions to a system or an apparatus, and by a computer (a CPU or an MPU) of the system or the apparatus reading and executing the program code stored in the storage medium. In this case, the program code read from the storage medium achieves the functions of the above exemplary embodiments, and the storage medium storing the program code can constitute the present disclosure.

As the storage medium for supplying the program code, a flexible disk, a hard disk, an optical disc, a magneto-optical disc, a Compact Disc Read-Only Memory (CD-ROM), a Compact Disc-Recordable (CD-R), a magnetic tape a non-volatile memory card, a ROM, or a Digital Versatile Disc (DVD) can be used.

Not only may the above functions be achieved by executing the program code read by the computer, but also the above functions may be achieved by an operating system (OS), while operating on the computer, performing a part or all of actual processing based on an instruction from the program code.

Further, the above functions may be achieved by writing the program code read from the storage medium to a memory included in a function extension board inserted into the computer or a function extension unit connected to the computer, and by performing a part or all of actual processing based on an instruction from the program code by a CPU included in the function extension board or the function extension unit.

LTE and 5G are merely examples of a wireless communication method compliant with the 3GPP standard. Alternatively, a method other than LTE and 5G may be used.

According to the present disclosure, a user of a communication terminal can identify a network slice specified by a network.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-085003, filed May 14, 2020, which is hereby incorporated by reference herein in its entirety.

What is claimed is:

1. A communication apparatus comprising:
an acquisition unit configured to acquire slice information regarding a network slice specified by a network; and
a control unit configured to control display according to a result of the acquisition of the slice information.

2. The communication apparatus according to claim 1, wherein, after a Radio Resource Control (RRC) connection is completed, the acquisition unit acquires the slice information.

3. The communication apparatus according to claim 1, further comprising a comparison unit configured to compare content of a communication function of the communication apparatus and the slice information acquired by the acquisition unit,
wherein the control unit controls display according to a result of the comparison of the comparison unit.

4. The communication apparatus according to claim 1, wherein, in a case where a message including the slice information regarding the network slice specified by the network is not received, the control unit performs warning display indicating that the network is incompatible with a slice.

5. The communication apparatus according to claim 1, further comprising a determination unit configured to determine whether a public land mobile network identifier (PLMN-ID) notified by a base station is publicly known,
wherein, in a case where the communication apparatus connects to the base station that notifies the communication apparatus of the publicly known PLMN-ID, the control unit controls display of the connection.

6. The communication apparatus according to claim 1, wherein, based on a classification to which the slice information acquired by the acquisition unit belongs, the control unit controls display according to the classification to which the slice information belongs.

7. The communication apparatus according to claim 1, wherein, in a case where the communication apparatus sets the network slice, the control unit does not control the display according to the result of the acquisition of the slice information.

8. The communication apparatus according to claim 1, wherein the slice information includes a value associated with a display content controlled by the control unit.

9. A communication apparatus comprising:
a specifying unit configured to specify a network slice to be provided via a network; and
a transmission unit configured to transmit a message including slice information based on which a display content according to the network slice is specified.

10. The communication apparatus according to claim 9, further comprising:
an identification unit configured to identify whether a setting request to set the network slice is made;
a determination unit configured to determine whether the network slice for which the setting request is made is providable;
a management unit configured to manage an RRC connection between a communication terminal having made the setting request and a base station; and
a processing unit configured to, in a case where the determination unit determines that the network slice for which the setting request is made is not providable, detach from the communication terminal having made the setting request while maintaining the RRC connection with the communication terminal.

11. A control method for controlling a communication apparatus, the control method comprising:
acquiring slice information regarding a network slice specified by a network; and
controlling display according to a result of the acquisition of the slice information.

12. A control method for controlling a communication apparatus, the control method comprising:
specifying a network slice to be provided via a network; and
transmitting a message including slice information based on which a display content according to the network slice is specified.

13. A non-transitory computer-readable storage medium storing a computer program for causing a computer to function as:
an acquisition unit configured to acquire slice information regarding a network slice specified by a network; and
a control unit configured to control display according to a result of the acquisition of the slice information.

14. A non-transitory computer-readable storage medium storing a computer program for causing a computer to function as:
a specifying unit configured to specify a network slice to be provided via a network; and
a transmission unit configured to transmit a message including slice information based on which a display content according to the network slice is specified.
